(19) United States
(12) Patent Application Publication
(10) Pub. No.: US 2006/0219163 A1
(43) Pub. Date: Oct. 5, 2006

(54) Recoater blade reservoir and adjustment mechanism for stereolithography rapid-prototyping systems that allows removal and replacement of the blade-reservoir without adjustment to the blade height or rake settings

(76) Inventors: Christian Merot, Santa Paula, CA (US); Andrew Christopher Graves, Newhall, CA (US); Vince Caltabiano, Castaic, CA (US)

Correspondence Address: Marty McGough;Total C S Team, Inc., 26820 Kendall Lane, Stevenson Ranch, CA, 91381, US

(21) Appl. No.: 11/396,170

(22) Filed: Mar. 31, 2006

Related U.S. Application Data
(60) Provisional application No. 60/667,556, filed on Apr. 1, 2005.

(51) Int. Cl. B05C 11/02

(52) U.S. Cl. 118/100; 118/200

(57) ABSTRACT

The invention consists of a replacement recoater blade system for stereolithography rapid prototyping systems. The replacement allows the blade-reservoir to be easily and quickly removed from the system for cleaning or replacement without change to the important gap or rake settings that determine how the blade functions with relation to the surface of the resin. Thus, the operator of a stereolithography system can remove and replace a blade-reservoir without going through the lengthy process of having a trained technician reset the system before it can build models again. Also, the replacement recoater blade system has a resin-level viewing window on both sides of the blade-reservoir. This allows faster setup and/or checking of the resin level within the blade and allows the operator to more easily monitor the level whilst the stereolithography system is building.

This application is a continuation of application No. 60/667,556, filed Apr. 1, 2005—now provisional.

### BACKGROUND OF THE INVENTION

The class of layer-additive rapid prototyping systems known as “stereolithography” use a liquid resin that is solidified in some manner, usually by an ultra-violet laser. Stereolithography systems use a recoater blade assembly to apply or remove resin to form subsequent layers. The blade is typically a passive doctor-type of blade or an active vacuum-assisted blade that holds liquid resin within its body and applies it as it passes over the model that is being built. The vacuum-assisted blade uses a vacuum pump to suck liquid resin up from the resin surface into the reservoir to a manufacturer-specified height.

Both types of blade require the distance from the bottom of the blade to the resin surface (the “gap”) to be set precisely. Additionally, the vacuum-assisted blade requires the angle of the blade from front to back relative to the resin surface (the “rake”) to be also set precisely.

The reservoir part of the vacuum-assisted blades typically become coated in debris from part building, which is difficult to remove while the blade is mounted to the stereolithography system. If the blade is removed for cleaning however, the gap and rake settings are lost and require re-setting by a skilled technician, which is a lengthy process.

Current reservoir-blades also make it difficult for operators of the stereolithography system to see whether the resin has been sucked into the blade to the correct height, as the window is small and only on one side of the blade—also the environment as well as the interior of the blade is dark. Additionally, operators of the stereolithography system prefer the window of the blade to be facing the front such that they can monitor the resin level inside during the building process. However, technicians (or operators) working on the stereolithography system prefer the window to be facing the back of the system such that they can easily set the resin level when adjusting the vacuum pump at the rear of the system.

### SUMMARY OF THE INVENTION

The invention consists of a replacement recoater blade system consisting of a blade-reservoir and adjustment mechanism for gap and rake that fits existing stereolithography systems and allows the reservoir-blade to be removed for cleaning or replacement without the gap or rake settings being disturbed. This allows the operators of the stereolithography systems to quickly remove and clean the blade or replace it without losing time when the stereolithography system could be building. It allows them to swap between different types of resin as a separate reservoir can be used with each resin. It also allows possible experimentation with differing blade-reservoir profiles but without upsetting the important adjustment settings for the gap and rake.

The invention also incorporates a larger viewing window for the reservoir-blade, which is present on both sides. This allows viewing from both front and back of the stereolithography system as well as a clearer view of the resin height within the blade, thus satisfying both the needs of the operator of the stereolithography system and the technician working on the vacuum system.

### DESCRIPTION OF THE SEVERAL VIEWS OF THE DRAWING

FIG. 1 is a perspective view of the whole recoater system including Blade-Reservoir (1), mounting bracket (4) and adjusting blocks (5, 6). It shows how the mechanism mounts onto the existing saddle (14) and recoater-rails (2) of the stereolithography rapid-prototyping system. Right-hand mechanism is a mirror image of the left. THIS IS THE PREFERRED FRONT PAGE VIEW

FIG. 2 is a front view of the Blade-Reservoir (1) showing the Tension Springs (9) that hold the blade in place and the resin-viewing window (12), which is the same on both the front and back of the Blade-Reservoir.

FIG. 3 is a perspective view of the left-hand mounting mechanism (the right-hand mechanism is a mirror image) showing the Cover (3), which also acts as a spring-clamp to hold the Blade-Reservoir in place.

FIG. 4 is a left-hand close-up perspective view similar to FIG. 3 but with the cover removed, showing the Tension Spring (9) beneath, sitting on Spring-Retainer Stud (18); and the Gap-Adjustment Block (6) sitting inside the Rake-Adjustment Block (5). Right-hand mechanism is a mirror image of the left.

FIG. 5 is a left-hand close-up perspective view showing the Gap-Stop Block (7) mounted inside the Gap-Adjustment Block (6). Right-hand mechanism is a mirror image of the left.

FIG. 6 is a close-up perspective view showing details of the left-hand Gap-Stop Block (7) with the adjustment screw (8) and the Gap-Adjust Pin (11) that supports the Blade-Reservoir. Right-hand mechanism is a mirror image of the left.

FIG. 7 is a close-up perspective view showing the left-hand end of the Reservoir-Blade (1) with the Blade Stop (10) that sits on the Gap-Adjust Pin (11). Right-hand mechanism is a mirror image of the left.

FIG. 8 is a top view of the complete left-hand adjustment mechanism showing the Rake-Adjustment Screws (15) and Rake-Locking Screw (16). The Alignment Slot (17) is used to hold the mechanism against the existing rail-saddle (14) during installation. Right-hand mechanism is a mirror image of the left.

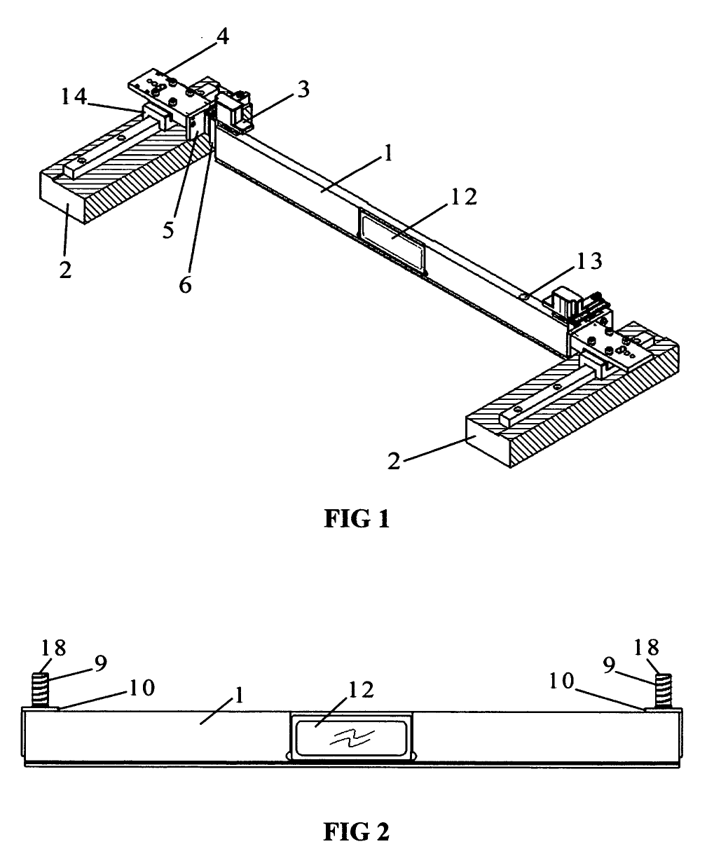

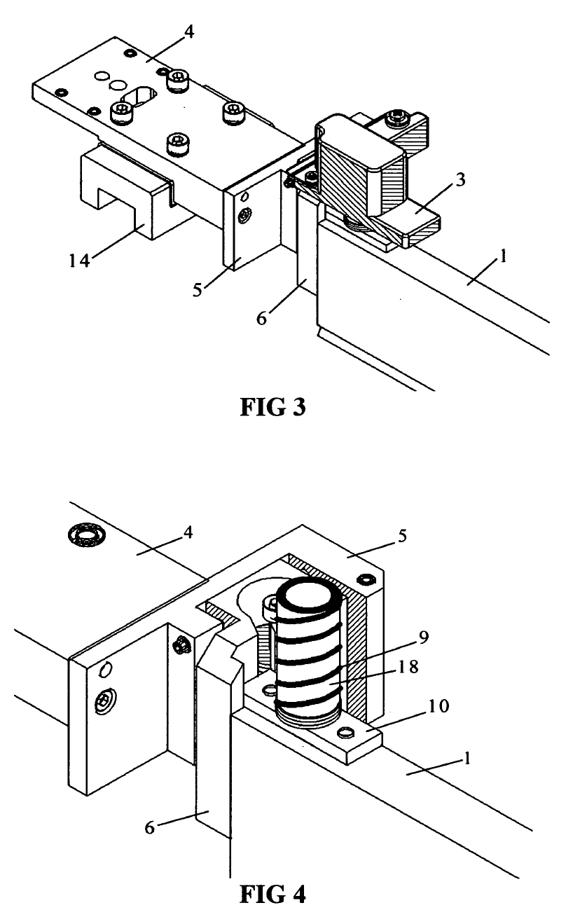

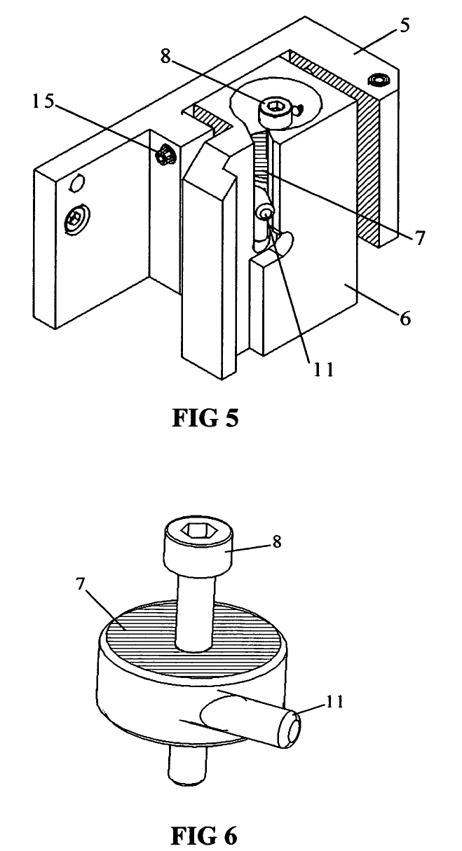

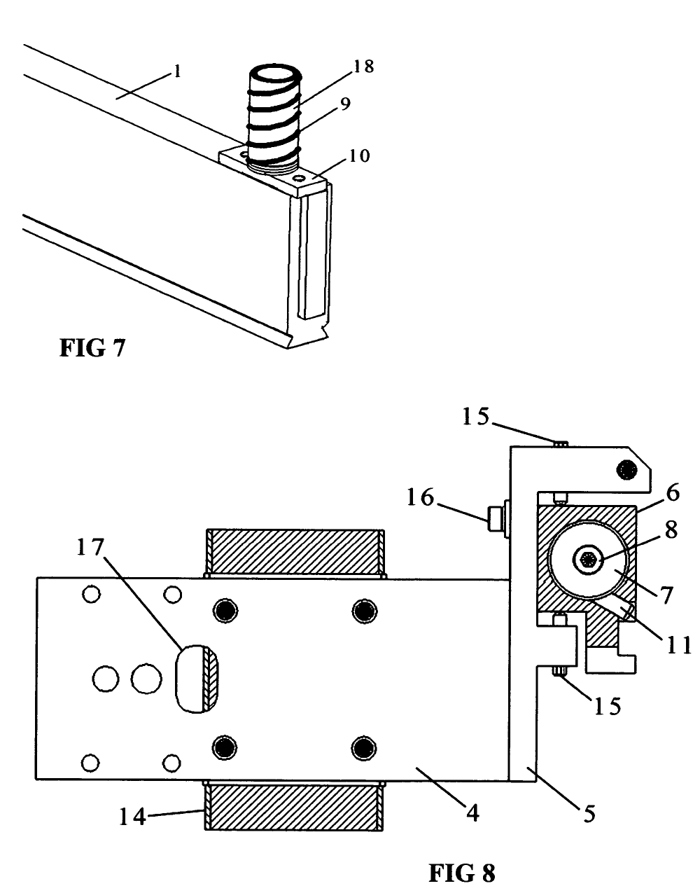

### DETAILED DESCRIPTION OF THE INVENTION

Manufacture

The components of the whole assembly must be capable of withstanding years of usage and adjustment within the environment of a stereolithography system. The adjustment mechanism would typically be made from a metal such as steel or aluminum, using commercially available fasteners. The Blade-Reservoir (1) could be made from steel, aluminum or a composite material that was stiff enough to withstand the forces encountered during recoating the resin. The Window (12) could be made from clear glass or clear composite but must be able to withstand chemical attack from the resin, as must the adhesive with which it is glued to the Blade-Reservoir.

Installation

The recoater blade reservoir and adjustment mechanism mounts to the existing rim (2) and rail-saddle (14) of the stereolithography system. The Mounting Brackets (4) are bolted to the saddle using a screwdriver or similar tool in the Alignment Slot (17) to force one of the Mounting Brackets against the machined edge of the saddle to provide a fixed reference point. The Rake-Adjustment Block (5) and Gap-Adjustment Block (6) are mounted to the Mounting Brackets on each side and support the Blade-Reservoir (1) between them. The Blade Stop (10) component of the blade assembly rests against the Gap-Adjustment Pin (11) to control the height of the blade above the resin surface.

A Tension Spring (9) is mounted over the Spring-Retainer Stud (18) and held in place by the Cover (3) to the force the blade assembly against the Gap-Adjust Pin and thus keep the bottom of the blade at the correct height above the resin surface.

The existing vacuum hose is connected to the Blade-Reservoir by means of the Hose Connection (13) on the right-hand side of the Blade-Reservoir.

Adjustment

The rake of the blade (angle front to back relative to the resin surface) is adjusted by first loosening the Rake-Adjustment Block Clamp Screw (16) then using a bubble-level on the underside of the Blade-Reservoir (1) and adjusting the Rake-Adjustment Screws (15) against each other at both ends of the blade assembly to ensure a level rake. Once level, the Rake-Adjustment Block Clamp Screw is re-tightened.

The gap (distance of the underside of the Blade-Reservoir from the resin surface) is adjusted by incrementally turning the Gap-Adjusting Screw (8), which raises or lowers the Gap-Stop Block (7) inside the Gap-Adjustment Block (6). The Gap-Adjustment Pin (11) is attached to the Gap-Stop Block (7) and the Blade Stop (10) component of the blade assembly is forced down against this, so moves up or down as the screw is adjusted, thus setting the correct gap.

The height of the resin inside the Blade-Reservoir is adjusted by the controls on the existing vacuum pump, but is made much easier by the fact that the resin level can be viewed from the front or the back of the stereolithography system and that the operator can see all the way through the Blade-Reservoir as it has Windows (12) on both sides.

Removing and Replacing the Blade-Reservoir Assembly

Once gap and rake are set, the Blade-Reservoir (1) can be removed easily by the operator of the stereolithography system without changing the gap or rake settings thus allowing removal and replacement without the need for a trained technician to reset the system.

The Cover (3) is removed on both sides, the vacuum hose is disconnected from the Blade-Reservoir at the connection (13) and the blade is simply lifted out for cleaning or replacement. The entire adjustment mechanism stays attached to the stereolithography system.

The Blade-Reservoir assembly is replaced by sliding it back into place such that the Blade Stops (10) sit against the Gap Adjustment Pins (11) and then the Covers are replaced over the Tension Springs (9), forcing the blade assembly to the correct height above the resin surface. The vacuum hose is re-connected to the Blade-Reservoir at the connection (13) and the resin level inside the Blade-Reservoir checked by observing the level through the Window (12).

What is claimed is:

1. We claim the invention of a replacement recoater blade system for stereolithography rapid prototyping systems that allows removal and replacement of the recoater blade-reservoir without changing or disturbing the settings of the gap between the bottom of the recoater blade-reservoir and the resin; or the rake angle of the recoater blade-reservoir relative to the resin.

2. We claim an invention that improves the way that resin level is set within a stereolithography blade by having a window on both sides of the blade-reservoir such that the resin level can be viewed from both the front and the back of the stereolithography system.
